(19) United States
(12) Patent Application Publication
(10) Pub. No.: US 2007/0021053 A1
(43) Pub. Date: Jan. 25, 2007

(54) Wireless satellite radio distribution network

(76) Inventor: Jeffrey J. Marrah, Kokomo, IN (US)

Correspondence Address: DELPHI TECHNOLOGIES, INC., M/C 480-410-202, PO BOX 5052, TROY, MI, 48007, US

(21) Appl. No.: 11/185,073

(22) Filed: Jul. 20, 2005

(51) Int. Cl. H04H 1/00

(52) U.S. Cl. 455/3.02

(57) ABSTRACT

A wireless satellite radio distribution network is disclosed. The wireless distribution network includes an integrated receiver/wireless router and at least one networked device. The integrated receiver/wireless router includes a receiving means that receives a plurality of compressed bit streams of satellite programming from a satellite signal. The integrated receiver/wireless router includes a distribution means for distributing one or more selected compressed bit streams of satellite programming from the plurality of compressed bit streams of satellite programming of the satellite signal over one or more routed network wireless paths to wirelessly distribute the selected one or more compressed bit stream(s) of satellite programming within a localized area. The at least one networked device is positioned in the localized area and includes a communication means for communicating over the one or more routed network wireless path. The at least one networked device is adapted to select and receive the distributed compressed bit stream of satellite programming from the plurality of compressed bit streams of a satellite signal within the localized area. A method is also disclosed.

### TECHNICAL FIELD

The disclosure generally relates to satellite radio programming distribution systems. More specifically, the disclosure relates to a satellite radio programming distribution system including a wireless distribution network.

### BACKGROUND

It is known that vehicles, homes, offices, and the like, may include a receiver that receives satellite radio programming, which is commonly referred to as satellite digital audio radio services (SDARS). SDARS audio is typically broadcast on the 2320-2345 MHz frequency range and covers a large geographic area, such as North America. Satellite-based digital audio radio services generally employ either geo-stationary orbit satellites or highly elliptical orbit satellites that receive up-linked programming, which, in turn, is re-broadcast directly to the receivers in the vehicles, homes, or offices on the ground. A subscription fee is typically required to receive the satellite services/satellite audio programming at each designated receiver on the ground.

Referring to FIG. 3, a conventional satellite radio system is shown generally at 100, which includes a home or office 102 having a plurality of rooms 104a-104d. The conventional satellite radio system 100 operates with a satellite 75 broadcasts satellite signals, S, to antennas 106a-106d respectively associated with conventional satellite receivers 108a-108d, which are respectively located in each room 104a-104d. The arrangement of conventional satellite receivers 108a-108d in each room 104a-104d permits a user in each room to selectively tune to a desired audio channel for audio output at speakers 110a-110d. Accordingly, a first user in room 104a may listen to satellite talk radio audio programming, while a second user in room 104b may listen to satellite country music programming, while a third user in room 104c may listen to satellite rock music programming, while a fourth user in room 104d may listen to satellite smooth jazz music programming. A conventional satellite receiver 108a-108d, for example, is sold under the trade-name SKI-FI® and is commercially available from XM® Satellite Audio Inc. of Washington, D.C.

Referring to FIG. 4, a conventional internet/computer audio system is shown generally at 200, which also includes a home, office, or the like at 202 having at least two rooms, which are shown generally at 204a and 204b. The first room 204a, may be, for example, a home office/computer room, that includes a modem 208, a wireless router 210, and a computer workstation 212, such as, for example, a laptop computer or desktop computer. The second room 204b, may be, for example, a home entertainment room including a wireless receiver 214 and a home theater system 250 including a home entertainment receiver 216, speakers 218, and a monitor 220.

The wireless router 210 has conventionally shared a first wireless path, R′, with the computer workstation 212 to provide wireless internet access from the internet 206 to the computer workstation 212. However, the conventional audio system 200 has also employed the wireless router 210 to share a second wireless path, R″, with the wireless receiver 214. Accordingly, the wireless router 210 may provide MP3 audio from the computer workstation 212 to the wireless receiver 214 over the first and second wireless paths R′, R″. Alternatively, internet radio audio may be provided from the internet 206 to the wireless receiver 214 from a coaxial cable port 201, through a coaxial cable line 203, an Ethernet network cable 205, and over the second wireless path R″. The MP3 or internet audio may be output by the speakers 218 of the home theatre system 250 via an audio cable 207 that connects the wireless receiver 214 and home entertainment receiver 216. The router 210 and the wireless receiver 214 are commercially available, for example, from LINKSYS® of San Jose, Calif. and sold as model numbers WAP54G and WMLS11B, respectively. Alternatively, the wireless receiver 214 is commercially available, for example, from APPLE COMPUTER® of Cupertino, Calif. and sold under the trade-name and AIRPORT® Express with AIRTUNES®.

Although the conventional satellite radio system 100 allows a user in each room 104a-104d to selectively tune a desired audio channel, the homeowner or office administrator must pay a subscription fee to receive satellite services from satellite signals, S, at each conventional satellite receiver 108a-108d. Even further, although the conventional internet/computer audio system 200 eliminates the wiring of audio cables throughout the home or office 202 from a first room 204a to a second room 204b while also providing the capability to play MP3 or internet radio audio over more powerful speakers 218 of the home theater system 250 rather than on weaker speakers of the computer workstation 212, the conventional audio system 200 does not permit the reception of satellite signals, S, to provide satellite programming in the first room 204a over the speakers of the computer workstation 212, nor over the speakers of a device in a different room, such as, for example the speakers 218 of the home theatre system 250 in the second room 204b. Even further, if a homeowner or office administrator subscribes to both satellite and internet services as shown in FIGS. 3 and 4, the homeowner or office administrator must pay subscriptions to a satellite service provider and also to an internet service provider while also buying, leasing, and/or maintaining equipment solely dedicated to providing satellite services and internet services, respectively.

### BRIEF DESCRIPTION OF THE DRAWINGS

The present disclosure will now be described, by way of example, with reference to the accompanying drawings, in which:

FIG. 1 illustrates a wireless satellite radio distribution network according to an embodiment;

FIG. 2 illustrates a block diagram of a networked wireless receiver node of the wireless satellite radio distribution network according to FIG. 1;

FIG. 3 illustrates a conventional satellite radio system; and

FIG. 4 illustrates a conventional internet/computer audio system.

### DESCRIPTION

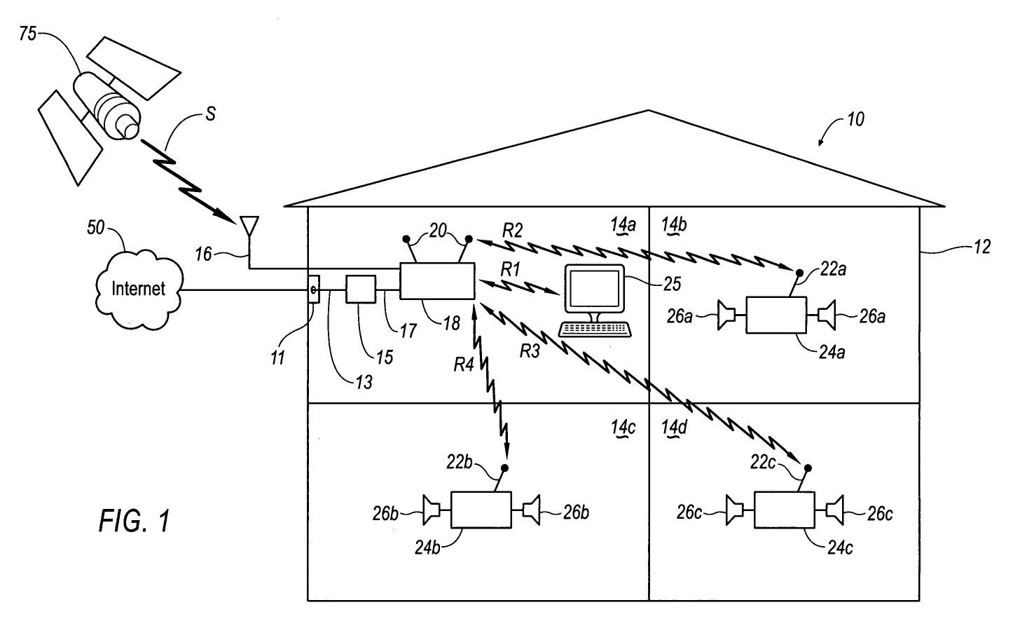

A wireless satellite radio distribution network is shown generally at 10 in FIG. 1 according to an embodiment. The wireless satellite radio distribution network 10 includes a localized area, such as a home, office, or the like, which is generally shown at 12, having a plurality of rooms 14a-14d, which are hereinafter referred to as the first, second, third, and fourth rooms, respectively. A primary satellite receiver including an integrated wireless router is shown generally at 18. The integrated satellite receiver/wireless router 18 includes a satellite antenna 16 and is shown proximate the first room 14a. Although the satellite antenna 16 is shown outside of the home or office 12, it will be appreciated that the satellite antenna 16 may be located within the home or office 12 such that the satellite antenna 16 is proximate the integrated satellite receiver/wireless router 18.

A plurality of networked wireless receiver nodes are shown generally at 24a-24c. The networked wireless receiver nodes 24a-24c do not directly receive satellite signals, S, but rather, the networked wireless receiver nodes 24a-24c receive a selected compressed satellite radio bit stream including satellite programming taken from the satellite signal, S. The satellite programming may include audio programming and streamed text data, such as weather, traffic, stock data, and the like. One of the networked wireless receiver nodes 24a-24c is shown in each of the second, third, and fourth rooms 14b-14d, respectively. Although only four rooms 14a-14d and three networked wireless receiver nodes 24a-24c are shown, it will be appreciated that any desirable number of rooms 14a-14d and any desirable number of networked wireless receiver nodes 24a-24c may be included in the satellite radio distribution network 10.

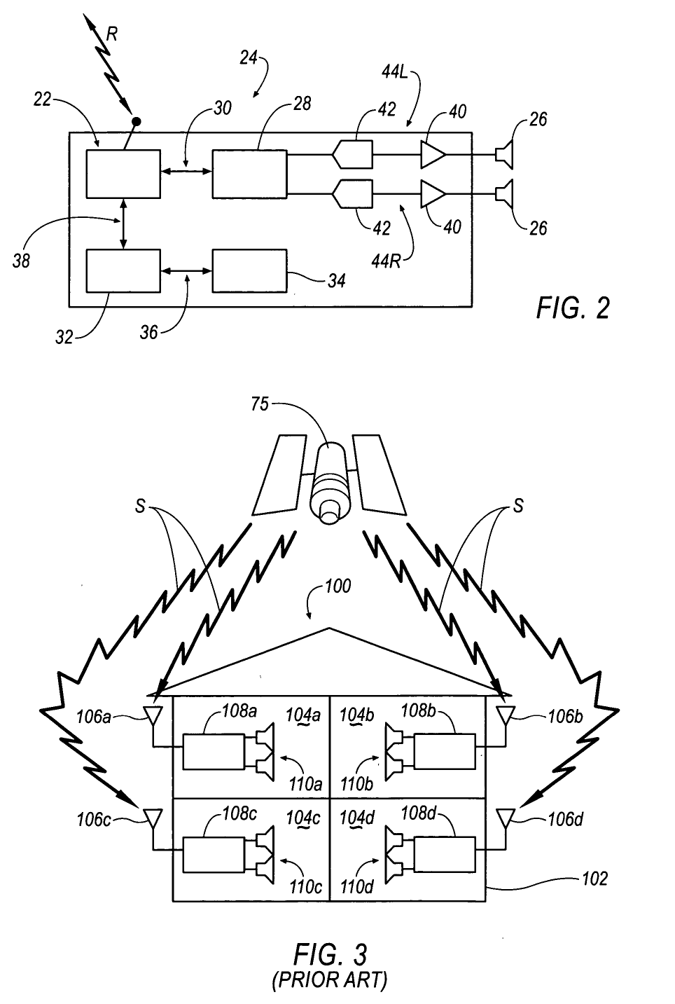

Referring to FIG. 2, a block diagram of a networked wireless receiver node is shown generally at 24. The networked wireless receiver node 24 receives the selected compressed satellite radio bit stream including satellite programming from the integrated satellite receiver/wireless router 18 over a routed wireless path, R, at an antenna unit 22. The antenna unit 22 includes bi-directional communication channels 30, 38 with a satellite audio decoder 28 and a microcontroller 32, respectively. A user interface 34 includes a bi-directional communication channel 36 with the microcontroller 32 as a means for node control of the integrated satellite receiver/wireless router 18 to allow selection of the satellite programming. Upon selecting the compressed satellite radio bit stream associated with the desired satellite programming at the user interface 34, the satellite audio decoder 28 decodes the compressed satellite radio bit stream, which is then passed through digital-to-analog converters 42 and amplifiers 40 before being output at speakers 26 of a left audio channel 44L and a right audio channel 44R. The user interface 34 may also include selection/tuner buttons as well as a screen to view and select satellite programming from a listing of available programming. Volume control buttons, audio fade buttons (i.e. left, right, front, and rear fade), and the like, may also be provided on the user interface 34.

Referring to FIG. 1, the integrated satellite receiver/wireless router 18 operates on the same principles of well-known satellite receiver electronics and Wireless-B (i.e. 802.11) or Wireless-G (i.e. 802.11g) routing/router devices. The satellite receiver electronics may, for example, process SDARS signals broadcast on the 2320-2345 MHz frequency range. Accordingly, it will be appreciated that the integrated satellite receiver/wireless router 18 may include satellite receiver electronics that receives and processes SDARS signals, S, and, if desired, wireless router electronics to send/receive the SDARS satellite information, internet information (e.g. internet radio), or other information (e.g. MP3s or the like) stored on the computer workstation 25 to/from distribution antennas 20 of the integrated satellite receiver/wireless router 18 to/from the networked wireless receiver nodes 24a-24c and/or a computer workstation 25 over routed network wireless paths R1-R4. As such, satellite/internet programming or stored information originating from the satellite 75, internet 50, or computer workstation 25 may be output on any of the networked wireless receiver nodes 24a-24c, computer workstation 25, or integrated satellite receiver/wireless router 18 (i.e. if speakers are included thereon).

To receive satellite and/or internet services, an end-user may subscribe to a first service provider, such as XM® or SIRIUS®, to enable reception of satellite services at the satellite antenna 16. The end-user may also subscribe to a second service provider to obtain access to the internet 50 at the integrated satellite receiver/wireless router 18 from a port 11, cable 13, modem 15, and Ethernet network cable 17 located within the home or office 12. It will be appreciated that because the integrated satellite receiver/wireless router 18 of the wireless satellite radio distribution network 10 processes both satellite and internet information in one device, a single service provider may offer subscriptions to both the satellite services and the internet services.

As illustrated, the satellite antenna 16 receives the satellite signals, S, from a satellite 75. Upon receiving the satellite signals, S, the integrated satellite receiver/wireless router 18 sends and receives signals from the first room 14a over the routed wireless paths R2-R4 to antennas 22a-22c extending from the networked wireless receiver nodes 24a-24c located, respectively, in each of the second, third, and fourth rooms 14a-14d. Accordingly, broadcast satellite audio may be output over speakers 26a-26c that are integrated with or connected to each networked wireless receiver node 24a-24c. If desired, the integrated satellite receiver/wireless router 18 may include speakers to provide audio output of the satellite programming in the first room 14a. Alternatively, the broadcast satellite audio may also be communicated over routed wireless path, R1, to the computer workstation 25 for output over computer speakers (not shown).

Because the integrated satellite receiver/wireless router 18 may simultaneously receive and distribute many compressed satellite radio bit streams of programming from the satellite 75 to the networked wireless receiver nodes 24a-24c, end-users respectively located in each room 14a-14d may select any desirable programming that originates from a primary receiver source, such as the integrated satellite receiver/wireless router 18. As such, the homeowner or office administrator may pay for a single satellite service subscription to provide satellite programming to a plurality of rooms 14a-14d that includes a networked wireless receiver node 24a-24c or integrated satellite receiver/wireless router 18 including speakers.

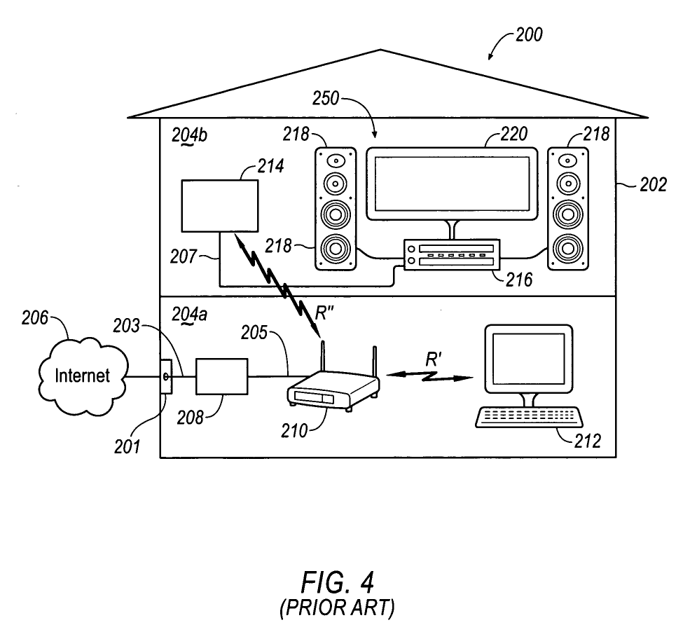

Accordingly, the integrated satellite receiver/wireless router 18 and networked wireless receiver node(s) 24a-24c of the wireless satellite radio distribution network 10 realizes cost savings for the homeowner, office administrator, or the like, because a single satellite service subscription is purchased rather than multiple satellite service subscriptions for a plurality of conventional satellite receivers 108a-108d as shown in FIG. 3. Even further, the integrated satellite receiver/wireless router 18 may also provide satellite radio programming over wireless path R1 to the computer workstation 25; as such, satellite radio programming may either be output over the speakers of the computer workstation 25, or, alternatively, the satellite radio programming may be saved in memory for later use on the computer workstation 25. Yet even further, it will be appreciated that although the illustrated embodiment in FIG. 1 shows a satellite 75 providing satellite signals, S, to the satellite antenna 16, the satellite antenna 16 may also receive a terrestrial re-broadcast of the satellite signals, S, if a signal loss or interruption occurs.

Also, because the integrated satellite receiver/wireless router 18 may include electronics that processes both satellite and internet information, satellite service providers, such as XM® or SIRIUS®, which have been typically limited to sales of satellite service subscriptions, may be enabled to broaden their customer base to include internet access subscriptions, and, conversely, internet service providers may broaden their customer base to include satellite service subscriptions. It will be appreciated that that regardless of the service provider that the end-user patronizes, the modem 15 may be owned by the end-user or leased/rented from the satellite/internet service provider to enable reception of internet services; however, if desired, the modem electronics may be integrated with the satellite receiver/wireless router 18 to reduce the number of components provided by the service provider if the components are leased/rented. Thus, the integrated satellite receiver/wireless router 18 may ultimately reduce the number of components and service providers within a localized area, such as a home or office 12. Even further, it will be appreciated that the satellite receiver/wireless router 18 may also include electronics associated with well-known set-top cable or satellite television boxes that provides digital cable programming. Accordingly, the satellite receiver/wireless router 18 may include the modem and/or set-top cable or satellite television box electronics to function as a streamlined device that may be sold by a commercial retailer or rented by a service provider when an end user subscribes to the service provider's services including, for example, satellite radio services, internet services, and/or cable/satellite television services.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A component of a wireless satellite radio distribution network, comprising:
an integrated receiver/wireless router including a receiving means that receives a plurality of compressed bit streams of satellite programming from a satellite signal; and
a distribution means for distributing one or more selected compressed bit stream(s) of satellite programming from the plurality of compressed bit streams of satellite programming of the satellite signal over one or more routed network wireless paths to wirelessly distribute the selected one or more compressed bit stream(s) of satellite programming within a localized area.

2. The component of the wireless satellite radio distribution network according to claim 1, wherein the distribution means operates with Wireless-B (802.11b) or Wireless-G (802.11g) routing.

3. The component of the wireless satellite radio distribution network according to claim 1, wherein the receiving means and distribution means includes one or more antennas.

4. The component of the wireless satellite radio distribution network according to claim 1, wherein the satellite programming is satellite audio programming or satellite data programming broadcast on the 2320-2345 MHz frequency range.

5. The component of the wireless satellite radio distribution network according to claim 4, wherein the an integrated receiver/wireless router includes speakers that outputs satellite audio programming.

6. The component of the wireless satellite radio distribution network according to claim 1, wherein the localized area is a home or office including a plurality of rooms where the one or more routed network wireless paths terminates for distribution of the selected one or more compressed bit stream(s) of satellite programming.

7. The component of the wireless satellite radio distribution network according to claim 1, wherein the integrated receiver/wireless router obtains access to internet information from the internet, wherein internet information is provided over the one or more routed network wireless paths to wirelessly provide the internet information within the localized area, wherein the internet information is internet radio programming.

8. The component of the wireless satellite radio distribution network according to claim 1, wherein the integrated receiver/wireless router obtains access to stored information from a computer workstation, wherein stored information is provided over the one or more routed network wireless paths to wirelessly provide the stored information within the localized area, wherein the stored information includes a plurality of MP3 files.

9. A component of a wireless satellite radio distribution network, comprising:
a networked device located in a localized area including a communication means for communicating over a routed network wireless path, wherein the networked device is adapted to select and receive a distributed compressed bit stream of satellite programming from a plurality of compressed bit streams of a satellite signal within the localized area.

10. The component of the wireless satellite radio distribution network according to claim 9, wherein the communication means operates with Wireless-B (802.11b) or Wireless-G (802.11g) routing.

11. The component of the wireless satellite radio distribution network according to claim 9, wherein the satellite programming is satellite audio or satellite data programming broadcast on the 2320-2345 MHz frequency range.

12. The component of the wireless satellite radio distribution network according to claim 11, wherein the communication means includes one or more antennas, wherein the one or more antennas includes bi-directional communication channels with a satellite audio decoder and a microcontroller, respectively, wherein the networked device includes a user interface having a bi-directional communication channel with the microcontroller as a means for selecting the compressed bit stream of satellite programming.

13. The component of the wireless satellite radio distribution network according to claim 12, wherein the satellite audio decoder decodes the selected compressed audio bit stream, wherein the decoded compressed audio bit stream is passed through digital-to-analog converters and amplifiers before being output at speakers of a left audio channel and a right audio channel.

14. A wireless satellite radio distribution network, comprising:
an integrated receiver/wireless router including an antenna that receives satellite signals including satellite programming, wherein the integrated receiver/wireless router wirelessly routes available satellite programming to one or more networked devices in a localized area over one or more routed network wireless paths.

15. The wireless satellite radio distribution network according to claim 14, wherein the integrated receiver/router and one or more networked devices operates with Wireless-B (802.11b) or Wireless-G (802.11g) routing.

16. The wireless satellite radio distribution network according to claim 14, wherein the satellite programming is satellite audio programming or satellite data broadcast on the 2320-2345 MHz frequency range.

17. The wireless satellite radio distribution network according to claim 14, wherein the integrated receiver/wireless router obtains access to internet information from the internet, wherein internet information is provided over the one or more routed network wireless paths to wirelessly provide the internet information to the one or more networked devices, wherein the internet information is internet radio programming.

18. The wireless satellite radio distribution network according to claim 14, wherein the one or more networked devices are one or more networked satellite receiver node(s) or a computer workstation.

19. The wireless satellite radio distribution network according to claim 18, wherein the integrated receiver/wireless router communicates over the one or more routed network wireless paths with the computer workstation to provide wireless access of the satellite programming to the computer workstation.

20. The wireless satellite radio distribution network according to claim 18, wherein the integrated receiver/wireless router communicates over the one or more routed network wireless paths with the one or more networked satellite receiver node(s) to provide wireless access of the satellite programming to the one or more network receiver node(s).

21. The wireless satellite radio distribution network according to claim 18, wherein the integrated receiver/wireless router obtains access to the computer workstation, wherein stored information on the computer workstation is provided over one or more routed network wireless paths to the integrated receiver/wireless router to wirelessly provide the stored information on the computer workstation to the one or more networked receiver node(s), wherein the stored information on the computer workstation are MP3 audio files.

22. A method for wirelessly distributing satellite radio, comprising the steps of:
receiving a plurality of compressed bit streams of satellite programming from a satellite signal (S) at an integrated receiver/wireless router proximate a localized area;
positioning one or more networked devices proximate the localized area,
distributing the compressed bit streams of satellite programming from the integrated receiver/wireless router to the one or more networked devices.

23. The method according to claim 22, prior to the distributing step, further comprising the step of utilizing the one or more networked devices to select a compressed bit stream of satellite programming from the plurality of compressed bit streams from the satellite signal.

24. A method for providing subscription services, comprising:
providing a plurality of available subscription services from a service provider; and
utilizing a single component at an end-user location to receive the plurality of subscription services, wherein at least one of the plurality subscription services received by the single component is satellite radio programming.

25. The method according to claim 24, wherein the plurality of subscription services receivable by the single component further comprises internet services and television services.
